(19) United States
(12) Patent Application Publication
(10) Pub. No.: US 2018/0242300 A1
(43) Pub. Date: Aug. 23, 2018

(54) USER DEVICE BEAM SELECTION FOR SCHEDULED UPLINK TRANSMISSION IN WIRELESS NETWORKS

(71) Applicant: NOKIA SOLUTIONS AND NETWORKS OY, Espoo (FI)

(72) Inventors: Sami-Jukka Hakola, Kempele (FI); Esa Tapani Tiirola, Kempele (FI)

(21) Appl. No.: 15/753,306

(22) PCT Filed: Aug. 17, 2015
(86) PCT No.: PCT/EP2015/068814

§ 371 Date: Feb. 17, 2018

(51) Int. Cl. H04W 72/04; H04L 5/00; H04B 7/08

(52) U.S. Cl. CPC H04W 72/046; H04B 7/086; H04L 5/0048

(57) ABSTRACT

A technique may include receiving, by a user device from an access point, reference signals; selecting, by the user device, a beam of a plurality of beams based on the reference signals; determining, by the user device, a time period when the access point allocates the selected beam to receive uplink signals; and sending, by the user device to the access point, a signal during at least a portion of the time period so that the access point receives the signal via allocation of the selected beam.

### TECHNICAL FIELD

This description relates to communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. S-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments.

A global bandwidth shortage facing wireless carriers has motivated the consideration of the underutilized millimeter wave (mmWave) frequency spectrum for future broadband cellular communication networks, for example. mmWave (or extremely high frequency) may, for example, include the frequency range between 30 and 300 gigahertz (GHz). Radio waves in this band may, for example, have wavelengths from ten to one millimeters, giving it the name millimeter band or millimeter wave. The amount of wireless data will likely significantly increase in the coming years. Various techniques have been used in attempt to address this challenge including obtaining more spectrum, having smaller cell sizes, and using improved technologies enabling more bits/s/Hz. One element that may be used to obtain more spectrum is to move to higher frequencies, above 6 GHz. For fifth generation wireless systems (5G), an access architecture for deployment of cellular radio equipment employing mmWave radio spectrum has been proposed. Other example spectrums may also be used, such as cmWave radio spectrum (3-30 GHz).

### SUMMARY

According to an example implementation, a method may include receiving, by a user device from an access point, reference signals; selecting, by the user device, a beam of a plurality of beams based on the reference signals; determining, by the user device, a time period when the access point allocates the selected beam to receive uplink signals; and sending, by the user device to the access point, a signal during at least a portion of the time period so that the access point receives the signal via allocation of the selected beam.

According to another example implementation, an apparatus may include at least one processor and at least one memory including computer instructions, when executed by the at least one processor, cause the apparatus to: receive, by a user device from an access point, reference signals; select, by the user device, a beam of a plurality of beams based on the reference signals; determine, by the user device, a time period when the access point allocates the selected beam to receive uplink signals; and send, by the user device to the access point, a signal during at least a portion of the time period so that the access point receives the signal via allocation of the selected beam.

According to another example implementation, a computer program product may include a computer-readable storage medium and storing executable code that, when executed by at least one data processing apparatus, is configured to cause the at least one data processing apparatus to perform a method including: receiving, by a user device from an access point, reference signals; selecting, by the user device, a beam of a plurality of beams based on the reference signals; determining, by the user device, a time period when the access point allocates the selected beam to receive uplink signals; and sending, by the user device to the access point, a signal during at least a portion of the time period so that the access point receives the signal via allocation of the selected beam.

According to another example implementation, an apparatus may include means for receiving, by a user device from an access point, reference signals; means for selecting, by the user device, a beam of a plurality of beams based on the reference signals; means for determining, by the user device, a time period when the access point allocates the selected beam to receive uplink signals; and means for sending, by the user device to the access point, a signal during at least a portion of the time period so that the access point receives the signal via allocation of the selected beam.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example implementation.

FIG. 2 is a diagram of a wireless transceiver according to an example implementation.

FIG. 3 is a diagram illustrating a radio system architecture according to an illustrative example implementation.

FIG. 4 is a diagram illustrating an AP (access point) transmitting an uplink scheduling grant followed by a user device using the uplink resource to transmit to the AP according to an example implementation.

FIG. 5 is a diagram illustrating an example implementation of a user device receiving an uplink scheduling grant and then selecting a time period to send uplink signals to an access point so that the access point receives the signal via allocation of a user device-selected beam.

FIG. 6 is a diagram illustrating a downlink resource grant wherein the user device may transmit signals via one of multiple uplink resources according to an example implementation.

FIG. 7 is a flow chart illustrating operation of a user device according to an example implementation.

FIG. 8 is a block diagram of a wireless station (e.g., base station/access point or mobile station/user device) according to an example implementation.

### DETAILED DESCRIPTION

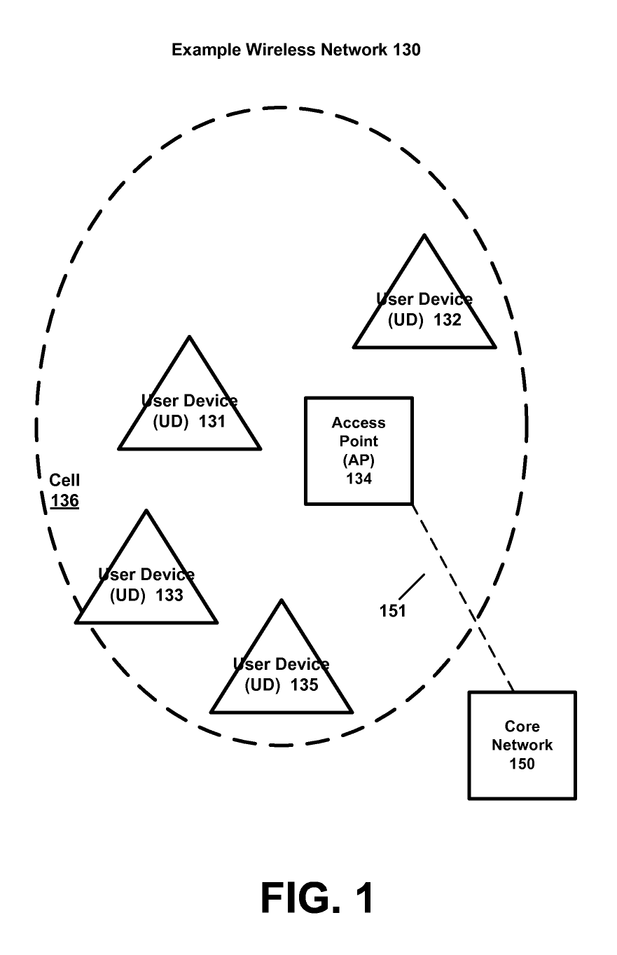

FIG. 1 is a block diagram of a wireless network 130 according to an example implementation. In the wireless network 130 of FIG. 1, user devices 131, 132, 133 and 135, which may also be referred to as mobile stations (MSs) or user equipment (UEs), may be connected (and in communication) with an access point (AP), which may also be referred to as a base station (BS) or an enhanced Node B (eNB). At least part of the functionalities of an access point (AP), base station (BS) or (e)Node B (eNB) may be also be carried out by any node, server or host which may be operably coupled to a transceiver, such as a remote radio head. AP 134 provides wireless coverage within a cell 136, including to user devices 131, 132, 133 and 135. Although only four user devices are shown as being connected or attached to AP 134, any number of user devices may be provided. AP 134 is also connected to a core network 150 via a S1 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

The various example implementations may be applied to a wide variety of wireless technologies or wireless networks, such as LTE, LTE-A, 5G, cmWave, and/or mmWave band networks, or any other wireless network. LTE, 5G, cmWave and mmWave band networks are provided only as illustrative examples, and the various example implementations may be applied to any wireless technology/wireless network.

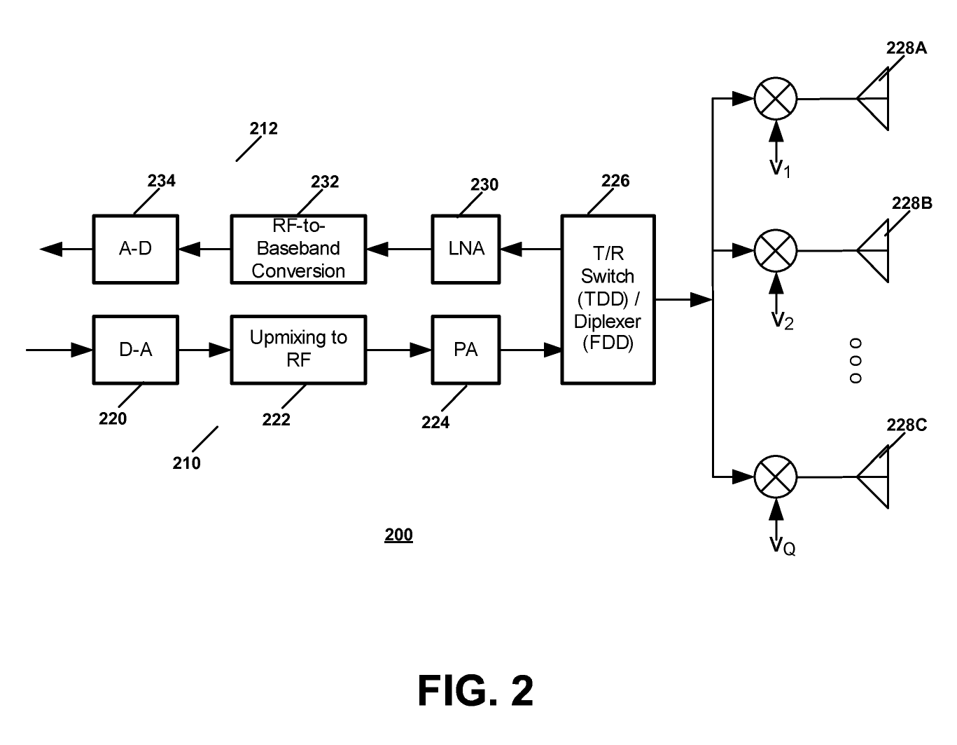

FIG. 2 is a diagram of a wireless transceiver according to an example implementation. Wireless transceiver 200 may be used, for example, at a base station (BS), e.g., Access Point (AP) or eNB, or other wireless device. Wireless transceiver 200 may include a transmit path 210 and a receive path 212.

In transmit path 210, a digital-to-analog converter (D-A) 220 may receive a digital signal from one or more applications and convert the digital signal to an analog signal. Upmixing block 222 may up-convert the analog signal to an RF (e.g., radio frequency) signal. Power amplifier (PA) 224 then amplifies the up-converted signal. The amplified signal is then passed through a transmit/receive (T/R) switch (or Diplexer 226 for frequency division duplexing, to change frequencies for transmitting). The signal output from T/R switch 226 is then output to one or more antennas in an array of antennas 228, such as to antenna 228A, 228B and/or 228C. Prior to being transmitted by one or more of the antennas in the array of antennas 228, a set of beam weights V₁, V₂, . . . or V_{Q} is mixed with the signal to apply a gain and phase to the signal for transmission. For example, a gain and phase, V₁, V₂, . . . or V_{Q}, may be applied to the signal output from the T/R switch 226 to scale the signal transmitted by each antenna (e.g., the signal is multiplied by V₁ before being transmitted by antenna 1 228A, the signal is multiplied by V₂ before being transmitted by antenna 2 228B, and so on), where the phase may be used to steer or point a beam transmitted by the overall antenna array, e.g., for directional beam steering. Thus, the beam weights V₁, V₂, . . . or V_{Q} (e.g., each beam weight including a gain and/or phase) may be a set of transmit beamforming beam weights when applied at or during transmission of a signal to transmit the signal on a specific beam, and may be a set of receive beamforming beam weights when applied to receive a signal on a specific beam.

In receive path 212 of wireless transceiver 200, a signal is received via an array of antennas 228, and is input to T/R switch 226, and then to low noise amplifier (LNA) 230 to amplify the received signal. The amplified signal output by LNA 230 is then input to a RF-to-baseband conversion block 232 where the amplified RF signal is down-converted to baseband. An analog-to-digital (A-D) converter 234 then converts the analog baseband signal output by conversion block 232 to a digital signal for processing by one or more upper layers/application layers.

Various example implementations may relate, for example, to 5G radio access systems (or other systems) with support for Massive MIMO (multiple input, multiple output) and optimized for operating in high carrier frequencies such as cmWave frequencies (e.g. from 3 GHz onwards) or mmWave frequencies, as examples, according to an illustrative example implementation. Those illustrative systems are typically characterized by the need for high antenna gain to compensate for increased pathloss and by the need for high capacity and high spectral efficiency to respond to ever increasing wireless traffic. According to an example implementation, the increased attenuation at higher carrier frequencies may, for example, be compensated by introducing massive (multi-element) antenna arrays and correspondingly antenna gain via beamforming at the access point (AP)/base station (BS). The spectral efficiency may typically improve with the number spatial streams the system can support and thus with the number of antenna ports at the AP/BS.

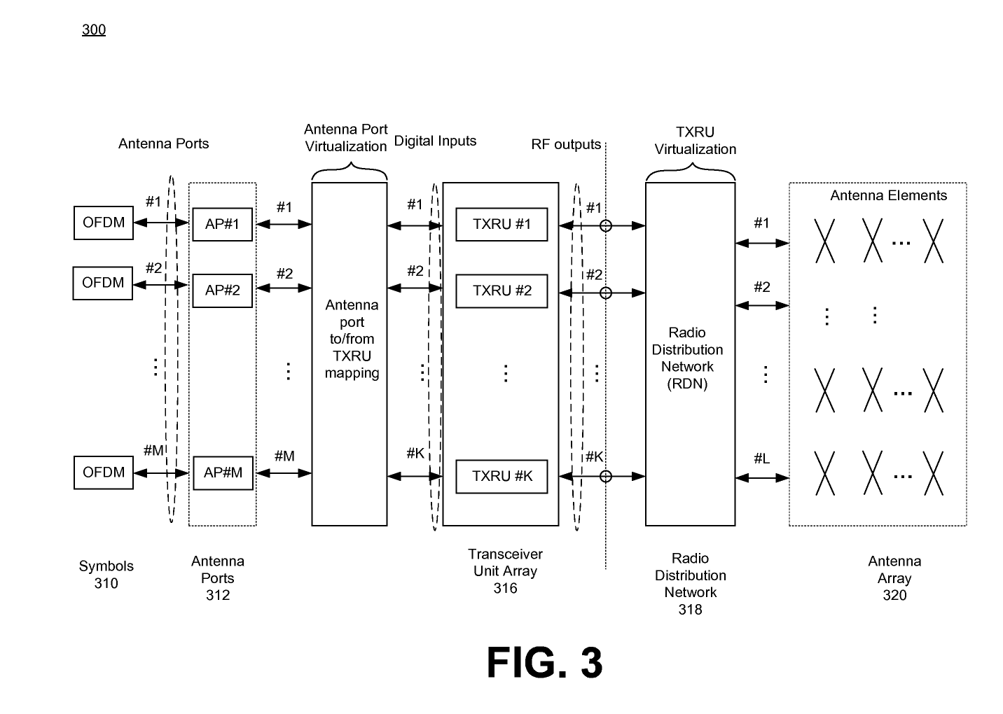

FIG. 3 is a diagram illustrating a radio system architecture according to an illustrative example implementation. Both transmit and receive directions are shown. In the transmit direction, radio system architecture 300 receives/generates multiple symbols (e.g., OFDM/orthogonal frequency division multiplex symbols) 310 which are mapped/provided to M antenna ports 312. Antenna ports 312 in this illustrative example does not refer to physical antenna ports. Rather, antenna ports 312, e.g., as defined by LTE as an illustrative example, refer to logical antenna ports (logical entities), which may be distinguished by their reference signal sequence. Multiple (logical) antenna port signals can be transmitted over a single antenna/single antenna array, for example. A transceiver unit array 316 includes K transceiver (wireless/radio transmitter/receiver) units (TXRUs). Antenna port virtualization block 314 performs mapping between M antenna ports and K digital inputs of transceiver unit array 316 (e.g., performs mapping between M antenna ports and K TXRUs). On the RF side of transceiver unit array 316, a radio distribution network 318 performs TXRU virtualization, e.g., by mapping or connecting each TXRU to one or more antenna elements of antenna array 320. One TXRU can be connected to {1 . . . L} antenna elements depending on the TXRU virtualization, i.e., mapping between TXRUs and Antenna Elements. Mapping can be either sub-array or full connection. In the sub-array model, one TXRU is connected to subset of antenna elements where different subsets may be disjoint while in the full connection model each TXRU is connected to each antenna element or all antenna elements of the antenna array 320. Radio distribution network (RDN) 318 performs antenna virtualization in the RF domain.

In the transmitting direction, M antenna ports feed K TXRUs, and K TXRUs feed L antenna elements where M≤K≤L, in this illustrative example implementation.

Complexity and power consumption of baseband processing may typically limit the number of antenna ports M to be much less than L in the cmWave system (as an illustrative example) where L can be from tens up to hundreds, for example. In an illustrative example implementation, power consumption of TXRUs (excluding power amplifier) is mainly due to DACs (digital to analog converter(s)) of which power consumption may typically be approximately linearly proportional to bandwidth and exponentially proportional to the number of ADC (analog to digital converter) bits (P B×22^{2R}; where B is bandwidth and R is bits per sample). As an example, typically 16 bit ADCs are used, e.g. in LTE. Thus, the power consumption of a TXRU may limit the feasible number of TXRUs being less than L. For example, in LTE, the number of TXRUs (i.e., K) defines the maximum number of antenna ports identified by CSI-RSs (Channel State Information Reference Signals) that can be defined and measured by the UE.

Different types of Adaptive Antenna Systems (AAS) or beamforming systems may be used, such as digital AAS, hybrid AAS and analog AAS, which some example implementations of these AAS systems may be summarized as follows, for example:

Digital AAS: one or more spatial layers per user device; digital precoding only; K=L (M<=K).

Analog AAS: one spatial layers per user device; no digital precoding, analog beamforming only; K<L (M=1); one-to-many mapping from TXRU to antenna elements.

Hybrid AAS: one or more spatial layers per user device; involves both analog and digital beamforming only (and digital precoding); K<L (M<=K); one-to-many mapping from TXRU to antenna elements.

Typically cellular systems, such as LTE, rely on sector wide beams for common control plane transmissions like downlink synchronization, broadcast, antenna port based common reference signals, etc. The systems operating on higher carrier frequencies may require relatively high antenna gain which means operating with narrow(er) beams. To support cell sizes with inter-site distance of, for example, tens to hundreds meters (merely an illustrative example) also common control plane signalling needs to utilize beams more narrow than sector. To provide coverage for the angular domain of the sector with narrow beams, multiple data self-containing beams may be generated.

Depending on the architecture and access point (AP) capabilities, the AP may not have hardware resources (i.e., TXRUs) or transmission power for generating so many beams in parallel that the whole sector could be covered at once, but rather operating requires sequential transmission of beam in different areas/portions of cell, e.g., for common control plane signalling in beam domain. Correspondingly in uplink, an AP/BS with hybrid architecture is capable of receiving only signals from directions the current RF beams are pointing to. In other words, it should be avoided that the user device transmits to AP when the AP has RF beam(s) directed to other directions than towards the transmitting user device. For example, if a user device is transmitting uplink to AP, and AP has a RF (radio frequency or MIMO) beam pointed in a different direction (not in direction of user device), then the transmitted signal may not obtain sufficient beamforming gain at AP, and as a result, the signals transmitted by the user device may not be successfully received and decoded by AP, for example (or at least it will be more difficult for AP to receive and decode such signals).

In the hybrid architecture, the AP has a limited amount of beam resources (TXRUs) available at a time. For example, the AP may have a limited number of TXRUs, such as, for example, 16, 8, 4, or other number. A general problem is to enable efficient use of limited beam resources in a multi-user system. More specifically, the AP may run short of beam resources, e.g., for the reception of uplink control symbol(s) into which the AP has configured PRACH (random access channel) and periodical SR (scheduling request) resources alongside HARQ (Hybrid ARQ/automatic repeat- request) ACK/NACK (acknowledgement/negative acknowledgement) and downlink CSI (channel state information) feedback resources for the user devices to send/transmit these signals uplink to the AP/BS. During the operation, the potential number of transmitting user devices may exceed the number of available beam resources, for example.

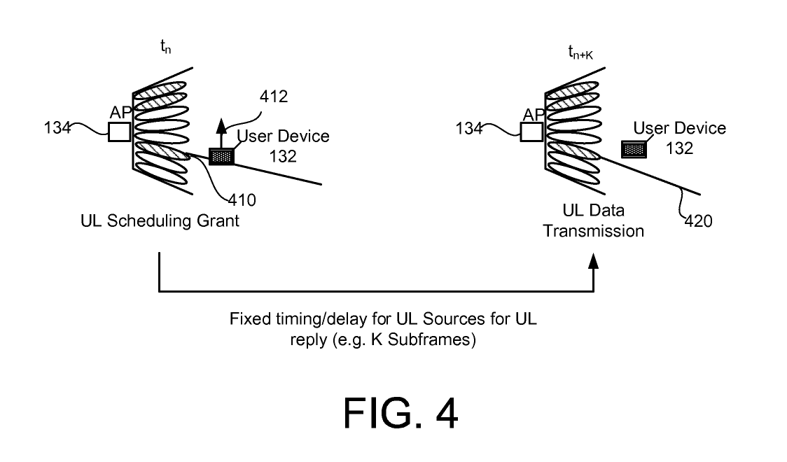

FIG. 4 is a diagram illustrating an AP transmitting an uplink scheduling grant followed by a user device using the uplink resource to transmit to the AP. In this example, AP 134 may send (via downlink control information) an uplink (UL) scheduling grant to the user device 132 in which the AP has a RF beam 410 pointed towards the user device 132. For example, the user device may periodically receive reference signals from the AP/BS, e.g., beam-specific reference signals, and may measure a channel quality parameter on these different beam-specific reference signals in order to select a best beam for the user device. For example, AP 134 may transmit a different beam-specific reference signal for one or more of the beams, or even, for example, for each of a plurality of RF/MIMO beams. The user device may measure, for example, a reference signal received power (RSRP) for one or more (or even each) of these beam-specific reference signals, and then may determine or select a best beam, e.g., a beam having a highest RSRP. The user device 132 may periodically report the best beam(s) to the AP 134. As a result, e.g., based on this reported best (or preferred) beam for the user device, the AP 134 may send/transmit the UL scheduling grant (which may identify uplink resources that may be used by the user device to transmit UL to the AP 134) to the user device 132 by allocating (or applying) beamforming weights to various antenna elements to generate the best beam 410, e.g., which may provide the highest or best beam-forming gain with respect to signals transmitted to the user device, for example. Alternative, rather than transmitting an UL scheduling grant, the AP 134 may transmit data (or other signals such as NACK) to the user device via beam 410, and it may be understood that the user device 132 would be automatically granted an uplink (UL) resource grant a fixed offset or fixed delay (e.g., 4 subframes later from the original data transmitted to the user device 132. For example, after AP 134 transmits data to user device via best beam 410, AP 134 may automatically grant user device a UL scheduling grant, or allocate UL resources four (as an example) subframes after the data transmission, e.g., for user device to send UL information, e.g., to send a HARQ Ack/Nak, a scheduling request or other information to the AP 134.

Therefore, with reference to FIG. 4, more generally, at time tₙ (e.g., where n may refer to the nth subframe, for example), the AP 134 may send data or other information (e.g., that would provide an UL scheduling grant at a fixed delay tₙ₊ₖ) to user device 132 via allocation of the (previously known) best beam 410. However, in this example, the user device 132 may have moved its location (or other change in the environment or circumstances for user device 132 that may result in a change of the channel for the user device 132), as indicated by line 412, such that beam 410 is no longer the best beam for user device 132, for example. Then at time tₙ₊ₖ, the user device 132 sends a reply or other information to the AP 134 via the granted UL resource, while AP 134 applies the previously known best beam 410. However, as shown in FIG. 4, due to movement of user device 132, or other changed circumstances or changed environment for user device 132, at time tₙ₊ₖ, the previously known best beam does not point in the direction of user device 132, as shown by line 420 which misses user device 132 (e.g., the applied/allocated beam at time tₙ₊ₖ is no longer in the direction of the user device 132). As a result, uplink performance may be significantly degraded. For example, the uplink information transmitted by the user device 132 to AP 134 at time tₙ₊ₖ (e.g., during subframe n+k) may not receive sufficient beamforming gain by AP 134 and thus, may not be received and decoded by AP 134, for example (data may be lost, due to use of a receive beam that is not best beam or is not pointed to user device 132). For example, the change in the channel (and thus, a change in a best beam for the user device 132) may occur at anytime since the last time the user device measured beam-specific reference signals from the AP 134 and/or reported its best beam to AP 134.

As noted above, the AP 134 may not have sufficient TXRU resources to allocate or apply signals to all areas or portion of a cell at once in order to receive uplink signals from one or more user devices. A beam schedule may identify time or timing for the AP's allocation/application of beams (e.g., receive beams) to receive uplink signals from various user devices. This beam schedule for the AP 134 may be provided to each user device, or may be known by each user device, for example (and may even be provided within or as part of an UL resource grant/UL scheduling grant). Thus, according to an example implementation, the AP 134 may apply one or more beams at sequential periods of time, e.g., a first set of receive beam(s) applied/allocated by AP 134 at tₙ, a second set of receive beam(s) applied/a/allocated by AP 134 at time tₙ₊₁, a third set of receive beam(s) applied/allocated by AP 134 at time tₙ₊₂, etc., until AP 134 has applied/allocated beams to all portions of a cell, e.g., to allow each user device to send data to AP 134 while the AP 134 is applying/allocating the best beam for the user device. Also, in another example implementation, AP 134 may apply one or more beams at non-sequential or non-contiguous periods of time/resources, such as at times, e.g., tₙ,tₙ₊ₖ, tₙ₊ₘ, etc.

However, according to an example implementation, the user device 132 may determine a (e.g., an updated or changed) best beam, which may be the same or may be different from the previously known best beam 410 used by AP 134 to transmit data, signals or an UL scheduling grant to the user device 132. User device 132 may also obtain or receive the beam schedule for the AP 134, e.g., to determine various times when different receive beams are applied/allocated by AP 134 to receive uplink signals from user devices. For example, this information, (e.g., a best beam of the user device 132, and the beam schedule for the AP 134) may then be used by the user device 132 to send a signal (e.g., data, control signals, or other information) to the AP during a time period when the AP 134 is allocating/applying the (e.g., new or updated) best beam for user device 132.

Thus, according to an example implementation, the user device 132 may receive, from an access point 134, reference signals; select, by the user device, a beam of a plurality of beams based on the reference signals; determine, by the user device, a time period when the access point allocates the selected beam to receive uplink signals; and, send, by the user device to the access point, a signal during at least a portion of the time period so that the access point receives the signal via allocation of the selected beam. In this illustrative example, the selected beam may be the best beam for user device 132, or may be a beam that is within a certain parameter range of the best beam, e.g., the selected beam may be a beam (or a reference signal for the beam) that has a RSRP that is within, e.g., 5% or 10%, of the RSRP of the best beam (the reference signal for the best beam), as measured by the user device based on the received reference signals, for example.

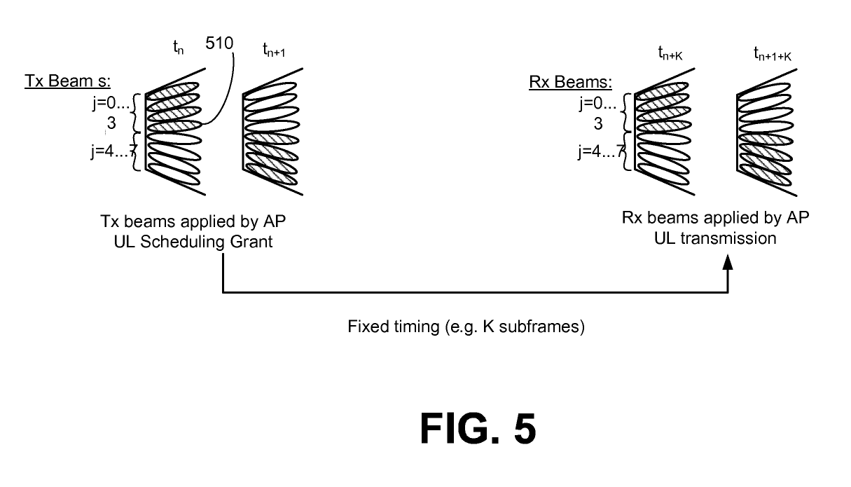

FIG. 5 is a diagram illustrating a user device (not shown in FIG. 5) receiving an uplink scheduling grant and then selecting a time period to send uplink signals to an access point so that the access point receives the signal via allocation of a user device-selected beam. In this illustrative example, there may be 4 TXRUs driving 8 beams, for example. Thus, for example, 4 beams may be driven or applied/allocated at a time by AP 134. Thus, in this illustrative example, for both transmitting downlink signals (using transmit/Tx beams) and receiving uplink signals (using receive/Rx beams), a first half of the beams (e.g., beams 0-3) may be applied/allocated by AP 134 during a first time period and a second half of the beams (e.g., beams 4-7) may be allocated/applied by the AP 134 during a second time period. Thus, as shown in the illustrative example of FIG. 5, AP 134 may apply/allocate beams 0-3 at time tₙ to transmit an uplink scheduling grant or data to user device 132 via beam 3 (for example), and possibly transmit downlink data to other user devices via other beams 0-2 during this time period. Beam 3 is merely an example of a currently (or previously) known best beam for user device 132, as known by AP 134. At time tₙ, AP 134 may transmit data (e.g., with an allocated uplink scheduling grant being provided a fixed time period later, e.g., k subframes later, or may transmit an uplink scheduling grant that allocates or grants UL resources K subframes later to user device 132, for example. Also, as shown in FIG. 5, the AP 134 may apply/allocate beams 4-7 at time tₙ₊₁ for the transmission of signals to one or more user devices, for example. In this example, the user device 132 may receive further beam-specific reference signals, and, e.g., due to a change in the user device location or other changes, the previously known best beam (beam 3 in this example) is no longer the best beam for the user device, but rather, now beam 4 (as an example) is the best beam for user device 132.

User device 132 may obtain or may receive a beam schedule for the AP 134, e.g., indicating which beams (e.g., both Tx beams and Rx beams) are applied/allocated by AP 134 during specific time periods. As shown in the illustrative example of FIG. 5, the beam schedule may indicate that the AP 134 allocates/applies beams (Rx beams) 0-3 during time period tₙ₊ₖ, and allocates/applies beams (Rx beams) 4-7 during time period tₙ₊ₖ₊₁. In this example, user device 132 may determine a time period when AP 134 allocates/applies the user device selected beam or user device best beam (e.g., beam 4 in this example). According to an example implementation, if the AP allocates the user device selected (or upgraded best) beam (beam 4) during the time period tₙ₊ₖ, then the user device may transmit data/signals via the uplink resource (e.g., allocated via the UL scheduling grant) allocated or granted to the user device during this time period tₙ₊ₖ. On the other hand, if the AP allocates/applies the selected (or upgraded best beam (e.g., beam 4) during the following time period at time period tₙ₊ₖ₊₁, then the user device will not use the granted/allocated UL resource at time period tₙ₊ₖ, but will transmit the data/signals to the AP 134 via a resource during the next time period at time period tₙ₊ₖ₊₁. Thus, in this example, user device 132 may determine that receive (Rx) beam 4 is applied by AP 134 during time period tₙ₊ₖ₊₁. Thus, the user device 132 will not use the originally granted UL resource at time period tₙ₊ₖ to send signals to the AP 134 because the AP 134 is not applying/allocating the upgraded/revised best beam (e.g., beam 4 in this example) during that time period. Rather, because the selected (upgraded/revised) best beam (beam 4 in this example) is allocated/applied by AP 134 during the subsequent time period at time period tₙ₊ₖ₊₁, the user device 132 will send signals to the AP 134 during the time period tₙ₊ₖ₊₁.

Various techniques may be used to allocate or provide uplink resource grants for the user device in multiple time periods. For example, an uplink scheduling grant may be sent to the user device, which may allocate an uplink resource for a first time period (e.g., time period tₙ₊ₖ) to send signals to the AP 134. Although not (necessarily) explicitly communicated to the user device, the AP 134 may also automatically allocate or grant an uplink resource during the subsequent time period (e.g., time period tₙ₊ₖ₊₁) for the user device to send signals to the AP 134. In this manner, the user device may select one of the multiple uplink resource provided or granted in multiple time periods, so that the user device may select a resource in a time period in which the AP is allocating/applying a user device-selected (upgraded or revised) best beam.

In another example implementation, the AP 134 may signal or communicate multiple uplink scheduling grants, wherein the multiple uplink scheduling grants may be communicated via one beam (e.g., by AP allocating or applying previously known best beam 3). For example, AP 134 may send, during time period tₙ, a control message that indicates multiple uplink scheduling grants to user device 132 including a first uplink scheduling grant for time period tₙ₊ₖ, and a second uplink scheduling grant for time period tₙ₊ₖ₊₁, for example. In another example implementation, the multiple uplink scheduling grants may be sent or communicated to user device via separate messages, e.g., sent during different time periods and/or via different beams, for example. For example, AP 134 may send a first uplink scheduling grant to user device via beam 3 during time period tₙ, which allocates or grants an uplink resource during time period tₙ₊ₖ. And, For example, AP 134 may send a second uplink scheduling grant to user device via beam 4 (for example or other beam during the time period tₙ₊₁) during time period tₙ₊₁, which allocates or grants a second uplink resource during time period tₙ₊ₖ₊₁. In this manner, the user device may select a beam (e.g., based on various beam-specific reference signals), determine a time period when the AP 134 will be allocating/applying the selected beam (e.g., based on a beam schedule or other beam information), and then sending/transmitting signals to the AP 134 during at least a portion of the determined time period so that the AP receives the signal via allocation/application of the selected (e.g., upgraded or revised best) beam. Other (including multiple) beams may also be applied/allocated by the AP 134 during the determined time period.

According to an example implementation, a specific mode, an RX (receive) beam selective transmission mode may be provided, for scheduling UL transmission in the massive MIMO architecture based on hybrid AAS. For example, in an illustrative example, the uplink scheduling timing is made dependent on the downlink cell portion Cell portion, for example, may refer to an angular domain portion of the angular domain of the cell/sector. Downlink cell portion transmission may include of one or multiple beam transmission specific measurements if configured to this mode by the AP. Thus, according to an example implementation, a cell portion may include a beam(s).

As a starting point, when user device receives UL scheduling grant from certain cell portion j at time tₙ, user device may assume that AP will be able to receive UL transmission from cell portion j, at time t_{n+K}, where K equals a predetermined scheduling delay/offset (defined e.g. in terms of subframes, such as 4 subframes later).

User device may be aware of BS's Rx cell portions that are available at time t_{n+K} (e.g., via beam schedule).

If the best DL cell portion/beam defined by user device (denoted as j) is among those cell portions (for example if j=0 . . . 3 at tₙ), user device may then keep the predetermined scheduling timing and make the UL transmission at time t_{n+K}
Else, If the best DL cell portion/beam defined by user device is not among those cell portions (j=0 . . . 3 at tₙ), then user device may then change the scheduling timing in a predetermined way. According to current example, the user device will make the UL transmission one time period later, e.g., at the time t_{n+1+K}, so as to transmit when AP is allocating/applying the best beam as defined/measured by user device.

In the following, further example implementations/details are described, by way of examples. The AP may configure multiple cell portions where each portion is a combination of one or multiple beams that can be identified by the user device from the beam specific reference signal, for instance. The AP/BS may activate and deactivate the functionality (i.e., RX beam selective transmission mode) by using common or user device specific control signalling. When configured/activated, an uplink grant signalled by the BS includes at least one or multiple resources formed from uplink time, frequency and spatial domain resources and associated downlink cell portion. Alternatively, the associated cell portion/beam may be replaced directly with the beams not to require the AP use the same beam set for the uplink as for the downlink (i.e., downlink cell portion/beam and uplink cell portion/beam comprising set of beams may be different). In the case when AP has only limited amount of channel information available or if the channel information is outdated, AP may utilize multiple DL beams & multiple grants to schedule uplink transmission. User device will make UL transmission according to scheduling/scheduling timing corresponding to best beam. User device may be able to identify, e.g., from UL scheduling grants that the same packet has been scheduled using multiple DL beams/UL grants. UL scheduling corresponding to multiple DL beams & multiple grants may relate to a scenario having beams with equal timing (e.g., tₙ) or different timing (tₙ and tₙ₊₁). In an example implementation, asynchronous HARQ is applied when the RX beam selective transmission mode is configured to the user device/UE. The AP/BS may configure different transmission parameters for the different grants—e.g., demodulation reference signal sequence may be different in one grant targeting at uplink transmission time n+K than in the other grant targeting at uplink transmission time n+M. Alternatively, the user device/UE may derive one or more transmission parameters for the scheduled transmission opportunities, e.g., based on one or more of the following: associated cell portion (or beam(s) within cell portion), UE ID, allocated resource elements, etc. The user device/UE may measure the downlink cell portion transmissions by making measurements on reference signals on beams forming a certain downlink cell portion. This process (user device receiving and measuring beam-specific reference signals) may run in background. When user device receives the grant signaling having multiple resource—downlink cell portion pairs, the user device may have the following options for the transmission (assuming that received grants involve different timing):
The user device/UE selects the grant that is associated to the downlink cell portion having the best measurement results, cell portion comprising a beam with the best RSRP measurement, for instance.
The user device/UE selects the grants that are associated to downlink cell portions having signal strength measurements within a certain window from the strongest signal strength measurement among the cell portions or beams within a certain cell portion signalled in the grant.
The user device/UE selects the grant associated to downlink cell portion from which the grant was transmitted and additional grant(s) based pre-determined rule, e.g. best additional cell portion/beam.

The various details or example implementations may be applied to, for example:

On user device/UE specific resources
a. Dynamically scheduled uplink data transmission and retransmission
b. Aperiodic buffer status reporting
c. Aperiodic CSI reporting
d. Aperiodic SRS
e. HARQ ACK/NACK

On common resource pool
a. PRACH
b. Contention based uplink data transmission.

Furthermore, periodic uplink transmission resources, like SR (scheduling request) resources and CSI (channel state information) resources, and PRACH (random access channel) resources may be configured with more static signalling and configuration wherein the AP/BS configures multiple transmission opportunities where each opportunity is associated with cell portion (or beams). The grant signalling for the periodic SR and CSI resources is user device/UE specific while PRACH configuration is signalled in broadcast information and possibly via user device/UE specific signalling. The same options could be applied for the user device to select the transmission resources within a period as above in case of dynamic grant signalling. The user device/UE may select the resource grant that is associated to the downlink cell portion/beam having the best measurement results.

According to an example implementation, a cell portion may include a beam, such as a beam with the best RSRP measurement, for instance. The user device/UE selects the grants that are associated to downlink cell portions/beams having signal strength measurements within a certain window from the strongest signal strength measurement among the cell portions or beams within a certain cell portion signalled in the grant. The UE selects the grant associated to downlink cell portion from which the grant was transmitted and additional grant(s) based pre-determined rule, e.g. best additional cell portion.

According to an example implementation, an AP/BS configures and activates the dependency of uplink transmission timing and DL cell portion/beam measurements. Digital architecture may utilize fixed timing and hybrid AP/BS transceiver architecture may utilize dynamic timing as a function of downlink cell portion/beam measurements. The reason is that the digital RX architecture can receive signals from “every direction” at once while the hybrid AAS/beamforming architecture can receive signals only from “directions” current RF beams are pointing to, and only a limited number of beams may be applied/allocated at a time. The AP/BS may signal (or communicate) the downlink cell portions/beams and related beams in system information that is accessible for a user device/UE when the user device/UE is performing initial access to the cell, for example. Furthermore, the AP/BS may typically transmit periodical cell/sector specific discovery signals in beam domain that user devices detect and measure. User device/UE may then keep track of cell portion/beam-based measurements over time.

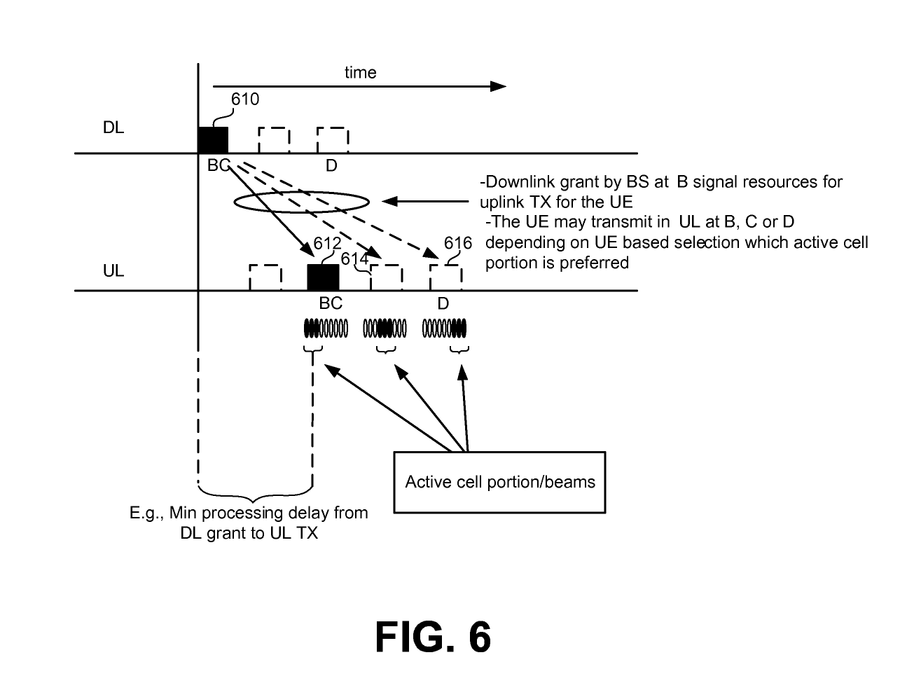

FIG. 6 is a diagram illustrating a downlink resource grant wherein the user device may transmit signals via one of multiple uplink resources according to an example implementation. Referring to FIG. 6, BS 134 may send an a grant 610 at B that is sent via allocation/application of B cell portions (e.g., beams associated with B), and which indicates an uplink resource grant for one or more of: 1) UL resource grant B 612 which uses B cell portions (or where AP applies B beams to receive signals); 2) UL resource grant C 614 which uses C cell portions/beams (or where AP applies C beams to receive signals), and 3) UL resource grant D 616 which uses D cell portions/beams (where AP applies D beams to receive signals). Also, in another example implementation, the grant 610 may only indicate the corresponding UP resource grant 612, but it may be understood by AP and user device that addition UL grants 614 and 616 are also available if user device selects a new (updated) best beam.

Therefore, the illustrative example techniques shown in FIG. 6 may have a number of benefits or advantages, such as for example: This technique provides AP/BS means to flexibly utilize its limited beam resources, especially in case a hybrid transceiver architecture is used; The illustrative example technique provides improved robustness for the uplink transmission by enabling user device/UE to select the best/preferred beam for UL transmission (AP reception). In this example, although not required, the measured downlink beams correspond to beams used for UL transmission/AP reception. Thus, these illustrative techniques may be used to determine that, for example, the DL beam used to transmit a grant for UL TX may not be the best beam for the user device/UE any longer, and the user device may then select a new/revised best beam, and transmit during a time period when such new/revised best beam is applied/allocated by the AP/BS.

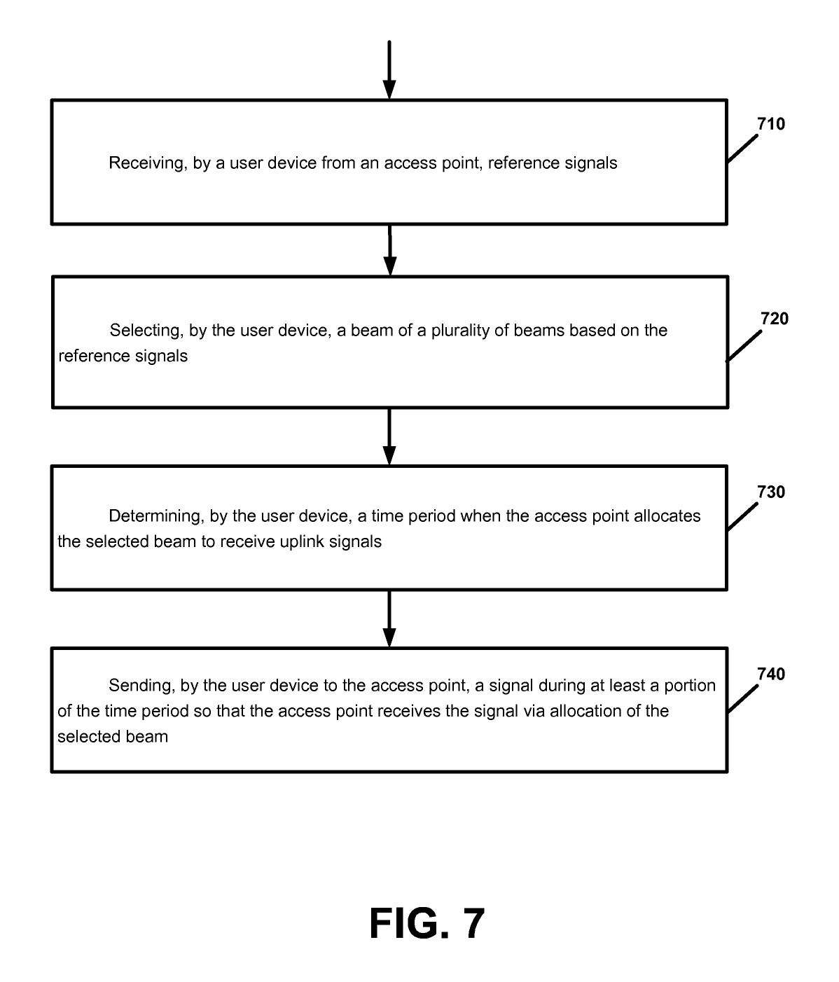

FIG. 7 is a flow chart illustrating operation of a user device according to an example implementation. Operation 710 may include receiving, by a user device from an access point, reference signals. Operation 720 may include selecting, by the user device, a beam of a plurality of beams based on the reference signals. Operation 730 may include determining, by the user device, a time period when the access point allocates the selected beam to receive uplink signals. And, operation 740 may include sending, by the user device to the access point, a signal during at least a portion of the time period so that the access point receives the signal via allocation of the selected beam.

According to an example implementation of the method of FIG. 7, the receiving may include: receiving, by the user device from the access point, beam-specific reference signals for one or more beams of the plurality of beams.

According to an example implementation of the method of FIG. 7, the selecting may include selecting, by the user device, a best beam, based on one or more signal parameters, as measured by the user device.

According to an example implementation of the method of FIG. 7, the selecting may include selecting, by the user device, a best beam having a highest reference signal received power of the plurality of beams, as measured by the user device.

According to an example implementation of the method of FIG. 7, the determining may include: receiving, by the user device from the access point, a beam schedule for the access point that identifies one or more beams that are allocated by the access point to receive uplink signals during one or more time periods; and determining, by the user device based on the selected beam and the beam schedule, a time period when the access point allocates the selected beam to receive uplink signals.

According to an example implementation of the method of FIG. 7, the receiving, by the user device from the access point, a beam schedule may include receiving, by the user device from the access point via one or more messages, an uplink resource grant and the beam schedule.

According to an example implementation of the method of FIG. 7, the method may further include: receiving a message by the user device from the access point, wherein a first uplink resource is provided a fixed delay from the message for the user device to send an uplink signal to the access point; wherein the sending comprises sending, by the user device to the access point, a signal via the first uplink resource if the first uplink resource is provided during a time period when the access point allocates the selected beam to receive uplink signals; and otherwise, the sending comprises sending, by the user device to the access point, a signal via a second uplink resource provided during a time period when the access point allocates the selected beam to receive uplink signals, if the first uplink resource is not provided during a time period when the access point allocates the selected beam to receive uplink signals and the second uplink resource is provided during a time period when the access point allocates the selected beam to receive uplink signals.

According to an example implementation of the method of FIG. 7, the method may further include: obtaining, by the user device from the access point: a first uplink resource provided to the user device for a first time period; a second uplink resource provided to the user device for a second time period; and selecting, by the user device, one of the first uplink resource and the second uplink resource, that is provided when the access point allocates the selected beam to receive uplink signals; and wherein the sending comprises sending, by the user device to the access point, a signal during at least a portion of the selected time period so that the access point receives the signal via allocation of the selected beam.

According to an example implementation of the method of FIG. 7, the method may further include determining, by the user device, a beam schedule for the access point that indicates one or more time periods during which the access point allocates one or more beams to receive uplink signals; determining, by the user device, an initial selected beam based on initial reference signals from the access point, the initial selected beam being allocated by the access point during a first time period to receive uplink signals; sending, by the user device to the access point, an indication of the initial selected beam; obtaining, by the user device from the access point, an uplink resource grant for the user device that grants a first uplink resource to the user device during the first time period; determining, by the user device, an updated selected beam based on further reference signals from the access point, wherein the updated selected beam is different from the initial selected beam and is allocated by the access point during a second time period that is different from the first time period; and wherein the sending comprises sending, by the user device to the access point, a signal during a second uplink resource provided during the second time period when the updated selected beam is allocated by the access point to receive uplink signals.

An apparatus may include at least one processor and at least one memory including computer instructions, when executed by the at least one processor, cause the apparatus to: receive, by a user device from an access point, reference signals; select, by the user device, a beam of a plurality of beams based on the reference signals; determine, by the user device, a time period when the access point allocates the selected beam to receive uplink signals; and send, by the user device to the access point, a signal during at least a portion of the time period so that the access point receives the signal via allocation of the selected beam.

According to an example implementation of the apparatus, the apparatus being configured to receive comprises being configured to: receive, by the user device from the access point, beam-specific reference signals for one or more beams of the plurality of beams.

According to an example implementation of the apparatus, the apparatus being configured to select may include being configured to: select, by the user device, a best beam, based on one or more signal parameters, as measured by the user device.

According to an example implementation of the apparatus, the apparatus being configured to receive may include being configured to: select, by the user device, a best beam having a highest reference signal received power of the plurality of beams, as measured by the user device.

According to an example implementation of the apparatus, the apparatus being configured to determine may include being configured to: receive, by the user device from the access point, a beam schedule for the access point that identifies one or more beams that are allocated by the access point to receive uplink signals during one or more time periods; and determine, by the user device based on the selected beam and the beam schedule, a time period when the access point allocates the selected beam to receive uplink signals.

According to an example implementation of the apparatus, the apparatus being configured to receive, by the user device from the access point, a beam schedule may include being configured to: receive, by the user device from the access point via one or more messages, an uplink resource grant and the beam schedule.

According to an example implementation of the apparatus, the apparatus may be further configured to: receive a message by the user device from the access point, wherein a first uplink resource is provided a fixed delay from the message for the user device to send an uplink signal to the access point; wherein being configured to send may include being configured to send, by the user device to the access point, a signal via the first uplink resource if the first uplink resource is provided during a time period when the access point allocates the selected beam to receive uplink signals; and otherwise, being configured to send comprises being configured to send, by the user device to the access point, a signal via a second uplink resource provided during a time period when the access point allocates the selected beam to receive uplink signals, if the first uplink resource is not provided during a time period when the access point allocates the selected beam to receive uplink signals and the second uplink resource is provided during a time period when the access point allocates the selected beam to receive uplink signals.

According to an example implementation of the apparatus, the apparatus being further configured to: obtain, by the user device from the access point: a first uplink resource provided to the user device for a first time period; a second uplink resource provided to the user device for a second time period; and select, by the user device, one of the first uplink resource and the second uplink resource, that is provided when the access point allocates the selected beam to receive uplink signals; and wherein the being configured to send may include being configured to send, by the user device to the access point, a signal during at least a portion of the selected time period so that the access point receives the signal via allocation of the selected beam.

According to an example implementation of the apparatus, and being further configured to: determine, by the user device, a beam schedule for the access point that indicates one or more time periods during which the access point allocates one or more beams to receive uplink signals; determine, by the user device, an initial selected beam based on initial reference signals from the access point, the initial selected beam being allocated by the access point during a first time period to receive uplink signals; send, by the user device to the access point, an indication of the initial selected beam; obtain, by the user device from the access point, an uplink resource grant for the user device that grants a first uplink resource to the user device during the first time period; determine, by the user device, an updated selected beam based on further reference signals from the access point, wherein the updated selected beam is different from the initial selected beam and is allocated by the access point during a second time period that is different from the first time period; and wherein the being configured to send comprises being configured to send, by the user device to the access point, a signal during a second uplink resource provided during the second time period when the updated selected beam is allocated by the access point to receive uplink signals.

A computer program product may include a computer-readable storage medium and storing executable code that, when executed by at least one data processing apparatus, is configured to cause the at least one data processing apparatus to perform a method including: receiving, by a user device from an access point, reference signals; selecting, by the user device, a beam of a plurality of beams based on the reference signals; determining, by the user device, a time period when the access point allocates the selected beam to receive uplink signals; and sending, by the user device to the access point, a signal during at least a portion of the time period so that the access point receives the signal via allocation of the selected beam.

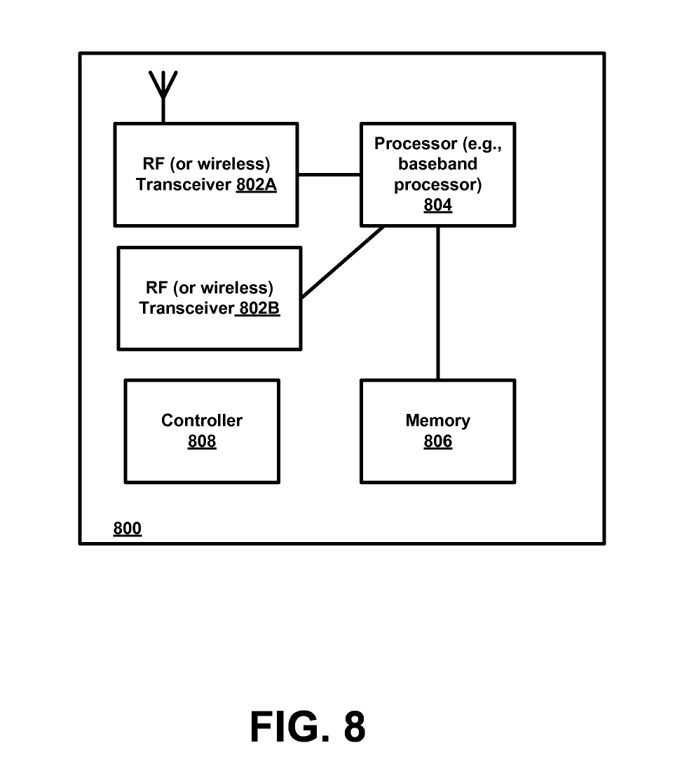

According to another example implementation, an apparatus may include means (e.g., 802A/802B and/or 804, FIG. 8) for receiving, by a user device from an access point, reference signals; means (e.g., 802A/802B and/or 804) for selecting, by the user device, a beam of a plurality of beams based on the reference signals; means (e.g., 802A/802B and/or 804) for determining, by the user device, a time period when the access point allocates the selected beam to receive uplink signals; and means (e.g., 802A/802B and/or 804) for sending, by the user device to the access point, a signal during at least a portion of the time period so that the access point receives the signal via allocation of the selected beam.

According to another example implementation of the apparatus, the means for receiving may include: means (e.g., 802A/802B and/or 804) for receiving, by the user device from the access point, beam-specific reference signals for each of a plurality of beams.

According to another example implementation of the apparatus, the means for selecting may include: means (e.g., 802A/802B and/or 804) for selecting, by the user device, a best beam, based on one or more signal parameters, as measured by the user device.

According to another example implementation of the apparatus, the means for selecting may include: means (e.g., 802A/802B and/or 804) for selecting, by the user device, a best beam having a highest reference signal received power of the plurality of beams, as measured by the user device.

According to another example implementation of the apparatus, the means for determining may include: means (e.g., 802A/802B and/or 804) for receiving, by the user device from the access point, a beam schedule for the access point that identifies one or more beams that are allocated by the access point to receive uplink signals during one or more time periods; and means (e.g., 802A/802B and/or 804) for determining, by the user device based on the selected beam and the beam schedule, a time period when the access point allocates the selected beam to receive uplink signals.

According to another example implementation of the apparatus, the means for receiving, by the user device from the access point, a beam schedule, may include: means (e.g., 802A/802B and/or 804) for receiving, by the user device from the access point via one or more messages, an uplink resource grant and the beam schedule.

According to another example implementation of the apparatus, the apparatus may further include means (e.g., 802A/802B and/or 804) for receiving a message by the user device from the access point, wherein a first uplink resource is provided a fixed delay from the message for the user device to send an uplink signal to the access point; wherein the means for sending may include means (e.g., 802A/802B and/or 804) for sending, by the user device to the access point, a signal via the first uplink resource if the first uplink resource is provided during a time period when the access point allocates the selected beam to receive uplink signals; and otherwise, the means for sending may include means (e.g., 802A/802B and/or 804) for sending, by the user device to the access point, a signal via a second uplink resource provided during a time period when the access point allocates the selected beam to receive uplink signals, if the first uplink resource is not provided during a time period when the access point allocates the selected beam to receive uplink signals and the second uplink resource is provided during a time period when the access point allocates the selected beam to receive uplink signals.

According to another example implementation of the apparatus, the apparatus may further include means (e.g., 802A/802B and/or 804) for obtaining, by the user device from the access point: a first uplink resource provided to the user device for a first time period; a second uplink resource provided to the user device for a second time period; and means (e.g., 802A/802B and/or 804) for selecting, by the user device, one of the first uplink resource and the second uplink resource, that is provided when the access point allocates the selected beam to receive uplink signals; and wherein the means for sending may include means (e.g., 802A/802B and/or 804) for sending, by the user device to the access point, a signal during at least a portion of the selected time period so that the access point receives the signal via allocation of the selected beam.

According to another example implementation of the apparatus, the apparatus may further include means (e.g., 802A/802B and/or 804) for determining, by the user device, a beam schedule for the access point that indicates one or more time periods during which the access point allocates one or more beams to receive uplink signals; means (e.g., 802A/802B and/or 804) for determining, by the user device, an initial selected beam based on initial reference signals from the access point, the initial selected beam being allocated by the access point during a first time period to receive uplink signals; means (e.g., 802A/802B and/or 804) for sending, by the user device to the access point, an indication of the initial selected beam; means (e.g., 802A/802B and/or 804) for obtaining, by the user device from the access point, an uplink resource grant for the user device that grants a first uplink resource to the user device during the first time period; means (e.g., 802A/802B and/or 804) for determining, by the user device, an updated selected beam based on further reference signals from the access point, wherein the updated selected beam is different from the initial selected beam and is allocated by the access point during a second time period that is different from the first time period; wherein the means for sending may include means (e.g., 802A/802B and/or 804) for sending, by the user device to the access point, a signal during a second uplink resource provided during the second time period when the updated selected beam is allocated by the access point to receive uplink signals.

FIG. 8 is a block diagram of a wireless station (e.g., AP or user device) 800 according to an example implementation. The wireless station 800 may include, for example, one or two RF (radio frequency) or wireless transceivers 802A, 802B, where each wireless transceiver includes a transmitter to transmit signals and a receiver to receive signals. The wireless station also includes a processor or control unit/entity (controller) 804 to execute instructions or software and control transmission and receptions of signals, and a memory 806 to store data and/or instructions.

Processor 804 may also make decisions or determinations, generate frames, packets or messages for transmission, decode received frames or messages for further processing, and other tasks or functions described herein. Processor 804, which may be a baseband processor, for example, may generate messages, packets, frames or other signals for transmission via wireless transceiver 802 (802A or 802B). Processor 804 may control transmission of signals or messages over a wireless network, and may control the reception of signals or messages, etc., via a wireless network (e.g., after being down-converted by wireless transceiver 802, for example). Processor 804 may be programmable and capable of executing software or other instructions stored in memory or on other computer media to perform the various tasks and functions described above, such as one or more of the tasks or methods described above. Processor 804 may be (or may include), for example, hardware, programmable logic, a programmable processor that executes software or firmware, and/or any combination of these. Using other terminology, processor 804 and transceiver 802 together may be considered as a wireless transmitter/receiver system, for example.

In addition, referring to FIG. 8, a controller (or processor) 808 may execute software and instructions, and may provide overall control for the station 800, and may provide control for other systems not shown in FIG. 8, such as controlling input/output devices (e.g., display, keypad), and/or may execute software for one or more applications that may be provided on wireless station 800, such as, for example, an email program, audio/video applications, a word processor, a Voice over IP application, or other application or software.

In addition, a storage medium may be provided that includes stored instructions, which when executed by a controller or processor may result in the processor 804, or other controller or processor, performing one or more of the functions or tasks described above.

According to another example implementation, RF or wireless transceiver(s) 802A/802B may receive signals or data and/or transmit or send signals or data. Processor 804 (and possibly transceivers 802A/802B) may control the RF or wireless transceiver 802A or 802B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input—multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1. A method comprising:
receiving, by a user device from an access point, reference signals;
selecting, by the user device, a beam of a plurality of beams based on the reference signals;
determining, by the user device, a time period when the access point allocates the selected beam to receive uplink signals;
sending, by the user device to the access point, a signal during at least a portion of the time period so that the access point receives the signal via allocation of the selected beam.

2. The method of claim 1 wherein the receiving comprises:
receiving, by the user device from the access point, beam-specific reference signals for one or more beams of the plurality of beams.

3. The method of claim 1 wherein the selecting comprises:
selecting, by the user device, a best beam, based on one or more signal parameters, as measured by the user device.

4. The method of claim 1 wherein the selecting comprises:
selecting, by the user device, a best beam having a highest reference signal received power of the plurality of beams, as measured by the user device.

5. The method of claim 1 wherein the determining comprises:
receiving, by the user device from the access point, a beam schedule for the access point that identifies one or more beams that are allocated by the access point to receive uplink signals during one or more time periods; and
determining, by the user device based on the selected beam and the beam schedule, a time period when the access point allocates the selected beam to receive uplink signals.

6. The method of claim 5 wherein the receiving, by the user device from the access point, a beam schedule comprises:
receiving, by the user device from the access point via one or more messages, an uplink resource grant and the beam schedule.

7. The method of claim 1 and further comprising:
receiving a message by the user device from the access point, wherein a first uplink resource is provided a fixed delay from the message for the user device to send an uplink signal to the access point;
wherein the sending comprises sending, by the user device to the access point, a signal via the first uplink resource if the first uplink resource is provided during a time period when the access point allocates the selected beam to receive uplink signals; and
otherwise, the sending comprises sending, by the user device to the access point, a signal via a second uplink resource provided during a time period when the access point allocates the selected beam to receive uplink signals, if the first uplink resource is not provided during a time period when the access point allocates the selected beam to receive uplink signals and the second uplink resource is provided during a time period when the access point allocates the selected beam to receive uplink signals.

8. The method of claim 1 and further comprising:
obtaining, by the user device from the access point:
a first uplink resource provided to the user device for a first time period;
a second uplink resource provided to the user device for a second time period; and
selecting, by the user device, one of the first uplink resource and the second uplink resource, that is provided when the access point allocates the selected beam to receive uplink signals; and
wherein the sending comprises sending, by the user device to the access point, a signal during at least a portion of the selected time period so that the access point receives the signal via allocation of the selected beam.

9. The method of claim 1 and further comprising:
determining, by the user device, a beam schedule for the access point that indicates one or more time periods during which the access point allocates one or more beams to receive uplink signals;
determining, by the user device, an initial selected beam based on initial reference signals from the access point, the initial selected beam being allocated by the access point during a first time period to receive uplink signals;
sending, by the user device to the access point, an indication of the initial selected beam;
obtaining, by the user device from the access point, an uplink resource grant for the user device that grants a first uplink resource to the user device during the first time period;
determining, by the user device, an updated selected beam based on further reference signals from the access point, wherein the updated selected beam is different from the initial selected beam and is allocated by the access point during a second time period that is different from the first time period; and
wherein the sending comprises sending, by the user device to the access point, a signal during a second uplink resource provided during the second time period when the updated selected beam is allocated by the access point to receive uplink signals.

10. An apparatus comprising at least one processor and at least one memory including computer instructions, when executed by the at least one processor, cause the apparatus to:
receive, by a user device from an access point, reference signals;
select, by the user device, a beam of a plurality of beams based on the reference signals;
determine, by the user device, a time period when the access point allocates the selected beam to receive uplink signals;
send, by the user device to the access point, a signal during at least a portion of the time period so that the access point receives the signal via allocation of the selected beam.

11. The apparatus of claim 10 wherein the apparatus being configured to receive comprises being configured to:
receive, by the user device from the access point, beam-specific reference signals for one or more beams of the plurality of beams.

12. The apparatus of claim 10 wherein the apparatus being configured to select comprises being configured to:
select, by the user device, a best beam, based on one or more signal parameters, as measured by the user device.

13. The apparatus of claim 10 wherein the apparatus being configured to receive comprises being configured to:
select, by the user device, a best beam having a highest reference signal received power of the plurality of beams, as measured by the user device.

14. The apparatus of claim 10 wherein the apparatus being configured to determine comprises being configured to:
receive, by the user device from the access point, a beam schedule for the access point that identifies one or more beams that are allocated by the access point to receive uplink signals during one or more time periods; and
determine, by the user device based on the selected beam and the beam schedule, a time period when the access point allocates the selected beam to receive uplink signals.

15. The apparatus of claim 14 wherein the apparatus being configured to receive, by the user device from the access point, a beam schedule comprises being configured to:
receive, by the user device from the access point via one or more messages, an uplink resource grant and the beam schedule.

16. The apparatus of claim 10 wherein the apparatus is further configured to:
receive a message by the user device from the access point, wherein a first uplink resource is provided a fixed delay from the message for the user device to send an uplink signal to the access point;
wherein being configured to send comprises being configured to send, by the user device to the access point, a signal via the first uplink resource if the first uplink resource is provided during a time period when the access point allocates the selected beam to receive uplink signals; and
otherwise, being configured to send comprises being configured to send, by the user device to the access point, a signal via a second uplink resource provided during a time period when the access point allocates the selected beam to receive uplink signals, if the first uplink resource is not provided during a time period when the access point allocates the selected beam to receive uplink signals and the second uplink resource is provided during a time period when the access point allocates the selected beam to receive uplink signals.

17. The apparatus of claim 10 and being further configured to:
obtain, by the user device from the access point:
a first uplink resource provided to the user device for a first time period;
a second uplink resource provided to the user device for a second time period; and
select, by the user device, one of the first uplink resource and the second uplink resource, that is provided when the access point allocates the selected beam to receive uplink signals; and
wherein the being configured to send comprises being configured to send, by the user device to the access point, a signal during at least a portion of the selected time period so that the access point receives the signal via allocation of the selected beam.

18. The apparatus of claim 10 and being further configured to:
determine, by the user device, a beam schedule for the access point that indicates one or more time periods during which the access point allocates one or more beams to receive uplink signals;
determine, by the user device, an initial selected beam based on initial reference signals from the access point, the initial selected beam being allocated by the access point during a first time period to receive uplink signals;
send, by the user device to the access point, an indication of the initial selected beam;
obtain, by the user device from the access point, an uplink resource grant for the user device that grants a first uplink resource to the user device during the first time period;
determine, by the user device, an updated selected beam based on further reference signals from the access point, wherein the updated selected beam is different from the initial selected beam and is allocated by the access point during a second time period that is different from the first time period; and
wherein the being configured to send comprises being configured to send, by the user device to the access point, a signal during a second uplink resource provided during the second time period when the updated selected beam is allocated by the access point to receive uplink signals.

19. A computer program product, the computer program product comprising a computer-readable storage medium and storing executable code that, when executed by at least one data processing apparatus, is configured to cause the at least one data processing apparatus to perform a method comprising:
receiving, by a user device from an access point, reference signals;
selecting, by the user device, a beam of a plurality of beams based on the reference signals;
determining, by the user device, a time period when the access point allocates the selected beam to receive uplink signals; and
sending, by the user device to the access point, a signal during at least a portion of the time period so that the access point receives the signal via allocation of the selected beam.

20. The computer program product of claim 19, and being further configured to cause the at least one data processing apparatus to perform:
receiving a message by the user device from the access point, wherein a first uplink resource is provided a fixed delay from the message for the user device to send an uplink signal to the access point;
wherein the sending comprises sending, by the user device to the access point, a signal via the first uplink resource if the first uplink resource is provided during a time period when the access point allocates the selected beam to receive uplink signals; and
otherwise, the sending comprises sending, by the user device to the access point, a signal via a second uplink resource provided during a time period when the access point allocates the selected beam to receive uplink signals, if the first uplink resource is not provided during a time period when the access point allocates the selected beam to receive uplink signals and the second uplink resource is provided during a time period when the access point allocates the selected beam to receive uplink signals.
